(19) United States
(12) Patent Application Publication
(10) Pub. No.: US 2012/0143663 A1
(43) Pub. Date: Jun. 7, 2012

(54) Tying Sweepstakes Incentive Rewards to Completion of Desired Fitness or Wellness Activity

(75) Inventors: James M. Miller, Sammamish, WA (US); Wade Andrew Pfeiffer, Mercer Island, WA (US); David P. Repp, Seattle, WA (US)

(73) Assignee: KARDIOFIT, INC., Bellevue, WA (US)

(21) Appl. No.: 13/248,885

(22) Filed: Sep. 29, 2011

Related U.S. Application Data
(60) Provisional application No. 61/387,601, filed on Sep. 29, 2010.

(51) Int. Cl. G06Q 30/02

(52) U.S. Cl. 705/14.14

(57) ABSTRACT

An indication is received with a computing device of a completion of a desired fitness or wellness event by a plurality of users of a multiplicity of users. In response to each completion of the desired fitness or wellness event by each of the plurality of users of the multiplicity of users, the user is entered into a sweepstakes. One of the entries in the sweepstakes is selected at random for a prize.

This application claims the benefit of U.S. provisional application No. 61/387601 filed Sep. 29, 2010.

### BACKGROUND

This application relates to systems and methods combining sweepstakes incentive rewards and issuance of sweepstakes entries tied to completion of desired activities centered on a fitness, wellness, diet and chronic disease/prescription management tracking system.

### BACKGROUND OF THE INVENTION

Some companies or health insurers use discounts on health insurance premiums or penalties to attempt to persuade consumers/Subscription Members to become more physically fit and lose weight. In 2010, approximately 67% of the U.S. population is considered overweight or obese. The passing of the Healthcare Bill has intensified the focus on bringing down healthcare costs and incentivizing doctors, insurance carriers to help make people healthier. The cost to employers of chronic disease such as obesity, Type II diabetes and heart disease is increasing at a rate of $13 trillion per year. U.S. healthcare is twice the cost per capita of any other industrialized nation U.S. healthcare costs are 4.3 times the amount spent on national defense and 16% of GDP.

Some companies or health insurers use gift cards or other monetary incentives to promote Subscription Member fitness and Incentive Subscription Members for losing weight. Although these monetary incentives are useful promotional tools, the cost of providing monetary prizes is prohibitively expensive for many companies.

### SUMMARY OF THE INVENTION

By receiving an Employer sponsored subscription the Employee becomes a “Subscription Member” to a PROGRAM that automatically renews, and automatically enters “active” Subscription Members in multiple Sweepstakes for as long as the Employer pays for the PROGRAM and the Subscription Member maintains active participation in the program. The PROGRAM offers a vast array of incentives, benefits, and special discounts that are updated one or more times a week to meet the ever-changing needs and desires of the Subscription Member.

In general, in one aspect, a method includes, receiving an indication with a computing device of a completion of a desired fitness or wellness event by a plurality of users of a multiplicity of users. In response to each completion of the desired fitness or wellness event by each of the plurality of users of the multiplicity of users, the user is entered into a sweepstakes drawing. One of the entries in the sweepstakes drawings is selected at random and the corresponding user to the entry is awarded prize.

In one implementation the user is entered into a sweepstakes during a predetermined term. In another implementation, the entry is selected after the expiration of the predetermined term. In a further implementation, the indication of the desired fitness or wellness event is provided by a device that monitors biometrics of one of the plurality of users. In an additional implementation, the indication is provided by the device to the computing device with a second computing device (such a as a smart phone, personal computer, laptop, PDA) via a network.

Additional features and variations found in still other embodiments include the following. The prize for at least one sweepstakes drawing is set to an amount above a predetermined minimum amount. If the at least one sweepstakes drawing fails to produce a winner, the prize for that sweepstakes drawing is rolled into the prize for a consecutive sweepstakes drawing. If a Subscription Member matches numbers in one sweepstakes drawing they could receive automatic entries into another sweepstakes drawing. Limiting the prize for at least one sweepstakes drawing to be less than or equal to a predetermined maximum amount. If the prize for the at least one sweepstakes drawing reaches the predetermined maximum amount and that sweepstakes drawing fails to produce a winner, conducting a second drawing to determine one or more winners of said prize. The second drawing includes randomly selecting a number from 1-70 to determine the number of winners of the prize. Or, if a predetermined date is reached and the prize for the at least one sweepstakes drawing has not reached the predetermined maximum amount, conducting additional drawings until there is a winner of the prize. The sweepstakes drawing includes identifying multiple winning entries, treating these entries as finalists, and holding a second drawing to determine a single winner. The one or more sweepstakes drawings may select a corresponding winner using a random number generation mechanism. The random number generation mechanism may include a computerized random number generator.

In general, in still another aspect, a computer implemented method includes enrolling a Subscription Member in a subscription to a product or service. The subscription has an Initial Term and is initially for an Initial Term. The method also includes, in connection with the subscription, automatically entering the Subscription Member into one or more sweepstakes drawings upon completion of events which occur during the Initial Term. The method also includes, at the end of the Initial Term, automatically renewing the subscription for a Renewal Term, and in connection with the renewed subscription, automatically entering the Subscription Member into a contest in which the member upon completion of an event/challenge is entered into one or more sweepstakes drawings which occur during the next time period. The operations of automatically renewing the subscription for a Renewal Term and automatically entering the Subscription Member into one or more contests which occur during the next time period are repeated until the Subscription Member terminates the Subscription Member subscription.

### BRIEF DESCRIPTION OF THE DRAWINGS

FIG. 1 is a simplified schematic diagram of a system for Tying Sweepstakes Incentive Rewards to Completion of Desired Fitness or Wellness Activity.

FIG. 2 is a simplified schematic diagram of an exemplary computing device used in the system for Tying Sweepstakes Incentive Rewards to Completion of Desired Fitness or Wellness Activity.

FIG. 3 is a simplified schematic diagram of an exemplary hosting computing device used in the system for Tying Sweepstakes Incentive Rewards to Completion of Desired Fitness or Wellness Activity.

FIG. 4 illustrates a flow chart of a process for Tying Sweepstakes Incentive Rewards to Completion of Desired Fitness or Wellness Activity.

### DETAILED DESCRIPTION

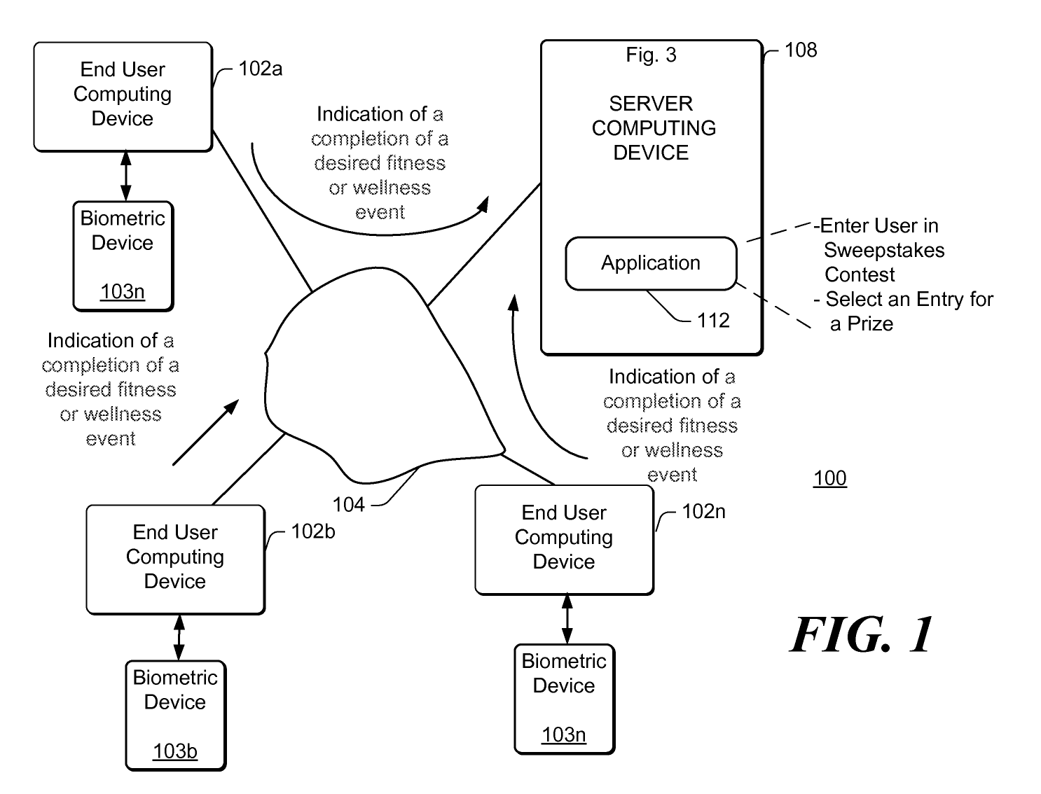

Referring to FIG. 1 there is shown a system for Tying Sweepstakes Incentive Rewards to Completion of Desired Fitness or Wellness Activity 100 including end user computing devices (also referred to herein as “personal computing devices”) 102a-102n coupled via a network 104 to one or more network server devices 108. In one implementation, each of the End User computing devices 102a is connected to a respective Biometric Device 103(a-n). Biometric device may be attached to a user or periodically attached to a user to monitor biometric/medical/wellness and/or fitness activities of the user.

Server computing device 108 is described communicating directly with computing devices 102a-102n; however, such communication is for illustration purposes only and in a typical implementation server computing device 108 communicates via network 104 to end user computing devices 102(a-n), other end user computing devices (not shown), and/or directly to a biofeedback device.

Server computing device 108 may be a network computer, host computer, network server, web server, email server or any computing device for hosting email communications applications and systems, one example of which includes a Microsoft® exchange server. Although end user computing devices 102(a-n) and client computing device are described as a personal computing device, devices 102(a-n) may be any type of computing device such as a cell phone, smart phone, laptop, mobile computer, desktop computer, personal computer, PDA, music player or game player device.

In one implementation, server computing device 108 includes one or more processors (not shown) and computer memory containing software application 112 which when executed by the processors, allows Tying Sweepstakes Incentive Rewards to Completion of Desired Fitness or Wellness Activity to the end user computing devices 102(a-n) via the network, to receive indications from biometric equipment 103(a-n) used by the end users, and display the results. The indications from the end user computing devices 102(a-n) may be an indication of a completion of a desired fitness or wellness event. The server computing device 108 may record and issue a sweepstakes ticket for each of the end users in which the server computing device receives an indication that the end user has reached predetermined targets in a desired fitness or wellness activity. In one implementation, such indications may be received from the end user by the end user entering data about the users completion of a desired fitness or wellness event using the computing device 102(a-n). Software application running on device 108 may be used to enter the user in a sweepstakes contest, and to select the winner of the contest for a prize. Criteria for an entry into the sweepstakes contest may be set by an administrator of the server computing device 108. In one implementation, the criteria may be set by an employer of the user.

Referring to FIG. 1, during operation the user of the end user computing device 102(a-n) or the biometric device 103(a-n) connected to the end user periodically (in one implementation, connects automatically) provides an indication to server device 108 of an indication of a completion of a desired fitness or wellness event. Server computing device 108 using application 112, enters information about the user into a sweepstakes contest and provides the user a ticket for the entry into the contest. Every time the user completes the desired fitness or wellness event, and the server computing device 108 receives an indication of such completion, the user is provided an additional entry and ticket into the sweepstakes. Upon the completion of a predetermined period of time, (“a Term”) the server computer device 108 generates a random number that is correlated to a ticket to select one of the entries in the sweepstakes for a prize.

Although only three end user computer devices 102a-102n, are described, the server computing device 108 may send notifications of entries in the sweepstakes to the end user computing devices, or to any device on the internet, a company intranet or the World Wide Web.

The server computing device 108 receives indications via network 104 from end user computing device 102a and end user computing devices 102(b-n). In one implementation when computing device 102a indicates a desired completion, it sends a unique identification code identifying that the request came from computing device 102a. Also when device 102b provides an indication, it sends a unique identification code identifying that the request came from computing device 102b. In one implementation, the unique identification code is stored in computing device 108 with the user that corresponds to the unique identification.

In another implementation server computing device 108 responds to the request from computing device 102a by feeding an electronic ticket of an entry into the sweepstakes via network 104 to computing device 102a, and responds to the request from computing device 102b by feeding an electronic ticket of an entry into the sweepstakes via network 104 to the computing device 102b.

Server computing 108 tracks the indications and unique identification codes. In addition server computing device 108 is programmed with the criteria required to complete the desired fitness or wellness event and the Term.

### Example Personal Computing Device Architecture

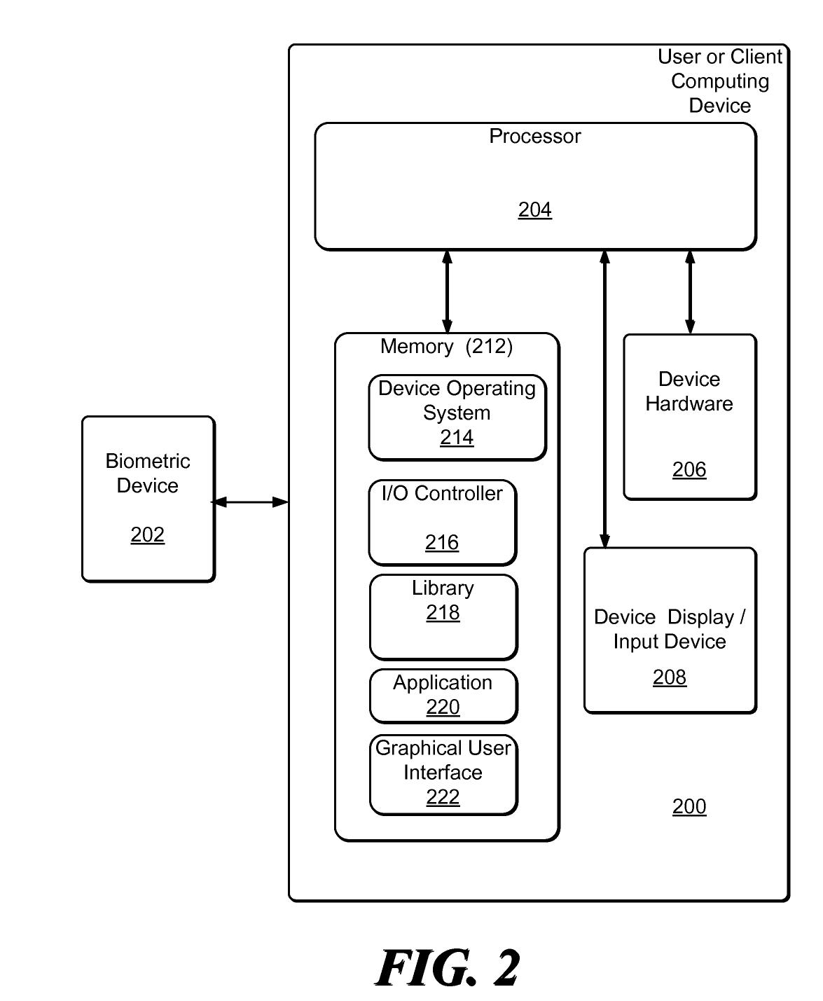

In FIG. 2 there are illustrated selected modules in Personal Computing Device 200 (computing devices 102a-n of FIG. 1) and biometric device 202 (biometric devices 103a-n of FIG. 1). Personal computing device 200 includes a processing device 204, memory 212, hardware 206 and display/input device 208. Processing device 204 may include a microprocessor, microcontroller or any such device for accessing memory 212, hardware 206 and display/input device 208. Processing device 204 has processing capabilities and memory suitable to store and execute computer-executable instructions. In one example, Processor 204 includes one or more processors 204.

Biometric device 202 connects to computing device 102 directly or wirelessly. Biometric device monitors activities/wellness of a user. Examples of biometric device 103 include a heart rate monitor, a pedometer, a GPS (Global Positioning System) tracking device, a stop watch, a blood level monitoring device (for measuring LDH, insulin levels or other blood levels), body temperature monitor, caloric intake monitor, body fat percentage monitor, or a weight monitor. The biometric device 103 may be programmed to automatically provide an indication on a particular event—such as when a blood level reaches a predetermined parameter for a predetermined period of time, or when a user's heart rate is within a particular zone for a predetermined period of time more than a predetermined number of times a week. Other examples of biometrics monitored by device 202 include cycling power, time to complete a race, number of hours of exercise per day, week or month, number of miles walked or run during a predetermined period of time, pace of a walk, percentage decrease of time to complete an event.

Processing device 204 executes instructions stored in memory 212, and in response thereto, processes signals from hardware 206 and display/input device 208. Hardware 206 may include network and communication circuitry for communicating with network 104 (FIG. 1). Display/Input device 208 receives inputs from a user of the personal computing device and may include a keyboard, mouse, track pad, microphone, audio input device, video input device, or touch screen display. Display device 208 may include an LED, LCD, CRT or any type of display device.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium (including a non-transitory computer readable storage medium) which can be used to store the desired information and which can be accessed by a computer system.

Modules stored in memory 212 of the personal computing device 200 may include an operating system 214, an I/O controller 216, a library 218, a browser application 220 and a graphical user interface 222. Operating system 214 may be used by application 220 to operate device 200. I/O controller 216 may provide drivers for device 200 to communicate with hardware 206 or device 208. Library 218 may include preconfigured parameters (or set by the user before or after initial operation) such as personal computing device operating parameters and configurations. Browser application may include a generally known network browser (including, but not limited to, Internet Explorer, Netscape Firefox, Oracle, Chrome or Safari) for displaying articles manifested as web pages received from the network or indications from Biometric device 202.

### Example Architecture

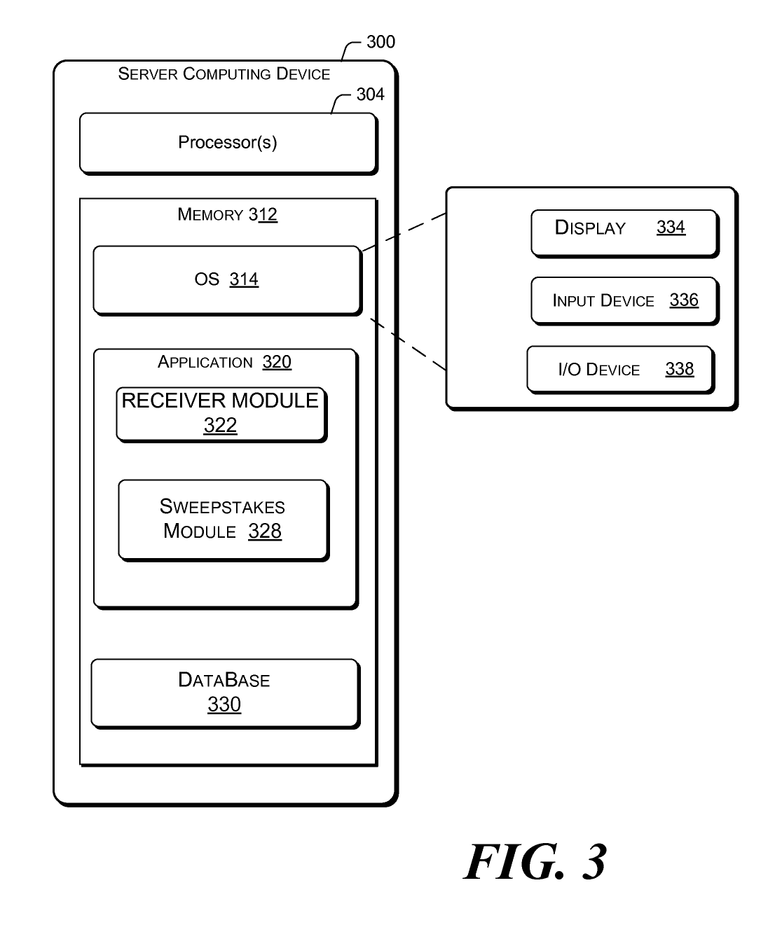

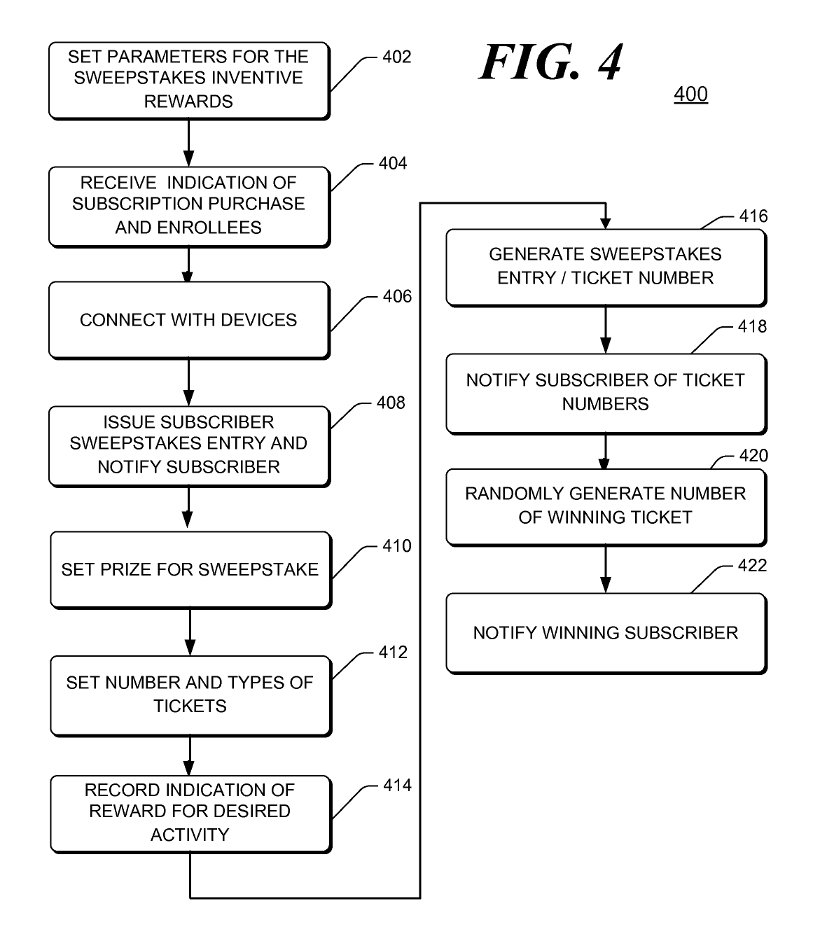

In FIG. 3 there are illustrated selected modules in host computing device 300 (Server Computing Device 108 of FIG. 1) using process 400 shown in FIG. 4. Hosting device 300 includes a processing device 304, memory 312, and hardware 314. Processing device 304 may include one or more a microprocessors, microcontrollers or any such devices for accessing memory 312 or hardware 314. Processing device 304 has processing capabilities and memory 312 suitable to store and execute computer-executable instructions.

Processing device 304 executes instruction stored in memory 312, and in response thereto, processes signals from hardware 314. Hardware 314 may include a display 334, and input device 336 and an I/O device 338. I/O device 338 may include a network and communication circuitry for communicating with network 104. Input device 336 receives data inputs from a user of the host computing device 300 and may include a keyboard, mouse, track pad, microphone, audio input device, video input device, or touch screen display. Display device 334 may include an LED, LCD, CRT or any type of display device.

Memory 312 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 312 of the hosting device 300 may include an operating system 314, application 320 and a library of other applications such as a database 330. Operating system 314 may be used by application 320 to operate device 300. The operating system 314 may include drivers for device 300 to communicate with input device 336 and I/O device 338. Database 330 may include preconfigured parameters (or set by the user before or after initial operation) such web site operating parameters, web site libraries, HTML libraries, API's and configurations.

Stored in the database in memory 312 are the parameters regarding the sweepstakes, the type of biometric devices supported, drivers for the biometric devices and information regarding the users—subscribers?

Application 320 includes a receiver module 322 and a sweepstakes module 328. Receiver module 324 and Sweepstakes module 328 are described in FIG. 4 in process 400 for Tying Sweepstakes Incentive Rewards to Completion of Desired Fitness or Wellness Activity. The exemplary process in FIG. 4 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 4, a flowchart of process 400 performed by processor 304 when executing the software instructions in application 320 is shown. Process 400 includes blocks 402-422. When application 320 is executed on the host processing device 300, it uses the processor 304 and instructions in modules 322-338 that are shown in FIG. 3.

In the process 400, the server computing device 300 (FIG. 3) in block 402, parameters for the sweepstakes inventive rewards and the issuance of additional sweepstakes entries is set to be tied to completion of desired activities centered on a fitness, diet, chronic disease management and prescription management tracking system or event within a predetermined Term.

In block 404, an indication is received from a business entity of a purchase a Subscription, along with an indication of which of the entities' Employees are enrolled. Sweepstakes entries may be provided as incentives to their Employees (Subscription Members) to participate in various fitness, diet, prescription medication, and chronic disease management activities, such as recording exercise, food consumption, sleep patterns, blood composition, completing surveys, watching videos, taking medication, completing a predetermined physical event (running a race, biking or running a predetermined distance), completing a predetermined physical event with an improved time over lastly completing the event, etc. . . . (Desired Activities).

In block 406, the Application is configured to connect with various devices such as fitness monitors, scales, computers, mobile phones, and software tracking programs in such computers or phones to record and track Subscription Member Desired Activities.

In block 408, a Subscription Member is automatically issued one Sweepstakes Entry upon completion of a desired action and/or upon signing up to participate in a desired activity. Upon the completion of additional Desired Action the Subscription Member is notified via website post, e-mail or text message and automatically issues additional Sweepstakes entries (a ticket) per Desired Action completed. The number or entries/tickets per user per time period (day, week, or month) may be limited.

In block 410, the Sweepstakes prizes are set. Such prizes may be set to be any amount. The quantity and timing of the sweepstakes drawings can be any day, week, month or multiple times a day.

In block 412 the maximum number and type of tickets that can be issued per Subscription member per day or per week is set. The number of tickets issued by day and activity can be modified.

In block 414, an Employer adds an indication of its rewards/prizes for Desired Activities recorded. Sweepstakes winners (both cash and non cash prizes) and the quantity, size, type and timing of the prizes offered can be preset or modified by the employer.

In block 416, each sweepstakes entry/ticket number is randomly generated. In one implementation the Subscription Member can select their sweepstakes entry/ticket numbers.

In block 418, the Employee and/or each Subscription member is notified of their ticket numbers or number of tickets for the sweepstakes provided to such Subscriber member. In one implementation, tickets are issued either collectively or individually either directly using email/chat/text messaging or using standard community software applications stored on the server.

In bock 420, a number is randomly generated corresponding to the winning ticket.

In block 422, the owner of winning ticket is notified, along with their prize.

In another implementation, depending on how the potential Subscription Member contacts the Company, either the Company's website or a live or automated operator informs the potential Subscription Member of the many benefits associated with a Subscription to the process for entering the sweepstakes (The program). The process includes the following information:

All the incentives, benefits, special deals and discounts associated with the PROGRAM updated one or more times a week to meet the ever changing needs and desires of Subscription Members.

Daily, Weekly, Monthly or Quarterly Giveaway. Automatic free entry into every Guaranteed Giveaway prize drawing, in which one or more lucky contestants are guaranteed to win a cash prize or a prize of equal value, held five times a week, once a month or once a quarter.

Mega Jackpot Sweepstakes. Automatic free entry into every Mega Jackpot prize drawing which are held multiple times a week.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method comprising:
receiving an indication with a computing device of a completion of a desired fitness or wellness event by a plurality of users of a multiplicity of users;
in response to each completion of the desired fitness or wellness event by each of the plurality of users of the multiplicity of users, entering said user into a sweepstakes; and
selecting one of the entries in the sweepstakes at random for a prize.

2. The method of claim 1, wherein said user is entered into a sweepstakes during a predetermined term.

3. The method as recited in claim 2, wherein the entry is selected after the expiration of the predetermined term.

4. The method as recited in claim 1, wherein the indication of the desired fitness or wellness event is provided by a device that monitors biometrics of one of the plurality of users.

5. The method as recited in claim 1, wherein the indication is provided by the device to the computing device with a second computing device via a network.

6. The method as recited in claim 5, wherein the second computing device is a smart phone.

7. The method as recited in claim 1, wherein the desired fitness or wellness event includes at least one of:
the user participating in a fitness activity, the user losing a predetermined amount of weight, the user having a predetermined blood composition, and the user completing a predetermined physical event with an improved time over lastly completing the event; and
wherein the indication is provided from a biometric device.

8. An apparatus comprising:
a computer system; and
computer-readable media storing program code which when executed on the computer system performs the functions of:
receiving an indication of a completion of a desired fitness or wellness event by a plurality of users of a multiplicity of users;
in response to each completion of the desired fitness or wellness event by each of the plurality of users of the multiplicity of users, entering said user into a sweepstakes; and
selecting one of the entries in the sweepstakes at random for a prize.

9. The apparatus as recited in daim 8, wherein said user is entered into a sweepstakes during a predetermined term.

10. The apparatus as recited in daim 9, wherein the entry is selected after the expiration of the predetermined term.

11. The apparatus as recited in claim 8, wherein the indication of the desired fitness or wellness event is provided by a device that monitors biometrics of one of the plurality of users.

12. The apparatus as recited in daim 8, wherein the indication is provided by the device to the computing device with a second computing device via a network.

13. The apparatus as recited in daim 12, wherein the second computing device is a smart phone.

14. The apparatus as recited in claim 8, wherein the desired fitness or wellness event includes at least one of:
the user participating in a fitness activity, the user losing a predetermined amount of weight, the user having a predetermined blood composition, and the user completing a predetermined physical event with an improved time over lastly completing the event; and
wherein the indication is provided from a biometric device.

15. A computer implemented method comprising:
a computer system; and
a non-transitory computer-readable media storing program code which when executed on the computer system performs the functions of:
a) receiving an indication of a completion of a desired fitness activity or wellness event by a plurality of users of a multiplicity of users;
b) in response to each completion of the desired fitness activity or wellness event by each of the plurality of users of the multiplicity of users, entering said user into a sweepstakes;
c) repeating operations (a) through (b) until the end of a predetermined term;
d) providing an indication of the entry in the sweepstakes to each of the entered users; and
e) selecting one of the entries in the sweepstakes at random for a prize.

16. The computer implemented method as recited in claim 15, wherein a non transitory computer-readable media storing program code which when executed on the computer system further performs the functions of:
e) receiving a unique identification with the indication of the desired physical activity from a biometric device; and
f) entering the user into the sweepstakes with the unique identification.
